(19) United States
(12) Patent Application Publication
(10) Pub. No.: US 2006/0066643 A1
(43) Pub. Date: Mar. 30, 2006

(54) Image display device and image signal processing device

(75) Inventors: Takayuki Arai, Hiratsuka-shi (JP); Tsutomu Sakamoto, Fukaya-shi (JP); Toshio Obayashi, Hiratsuka-shi (JP); Masao Yanamoto, Ichihara-shi (JP); Yasuhiro Ookawara, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/214,975

(22) Filed: Aug. 31, 2005

(30) Foreign Application Priority Data
Sep. 30, 2004 (JP) P2004-289119

(51) Int. Cl. G09G 5/10

(52) U.S. Cl. 345/690

(57) ABSTRACT

A judging unit compares data in a dither table for each display pixel with a numerical value of low-order 2 bits of an input signal (12 bits) and outputs 1 to an adder when the numerical value of the low-order 2 bits of the input signal is larger than the data in the dither table, while outputting 0 to the adder in other cases. The adder adds the value outputted from the judging unit to an uneven luminance correction value read from a correction memory, so that the uneven luminance correction value is corrected. A multiplier multiplies the input signal by the uneven luminance correction value after the correction.

### CROSS-REFERENCE TO RELATED APPLICATION

This application is based upon and claims the benefit of priority from the prior Japanese Patent Application No. 2004-289119, filed on Sep. 30, 2004; the entire contents of which are incorporated herein by reference.

### BACKGROUND OF THE INVENTION

1. Field of the Invention

The present invention relates to an image display device and an image signal processing device, and more particularly, to an image display device and an image signal processing device having a function of correcting variation in luminance (uneven luminance) among display pixels.

2. Description of the Related Art

As an image display device, for example, a FED (field emission display) which is a flat image display device using field emission type elements has been conventionally known. In such an image display device, variation in luminance (uneven luminance) among display pixels occurs due to characteristic difference among the elements. Therefore, the image display device is provided with an uneven luminance correction function of correcting an image signal by measuring the uneven luminance among the display pixels in advance, calculating uneven luminance correction values from the measurement results, and storing the uneven luminance correction values in a correction value memory (see, for example, Japanese Patent Laid-open Application No. 2004-157309).

In the image display device described above, an inputted image signal is corrected based on the aforesaid uneven luminance correction value and is further subjected to inverse Gamma correction. It is also known that there is a limit to the number of bits of data transmitted to a driver of a display, for example, 8 bits, 10 bits, or the like, and for gradation display with a larger number of bits than the limit, multi-gradation processing such as a dither method or error diffusion is applied (see, for example, Japanese Patent Laid-open Application No. 2002-91371).

In general, a multi-gradation processing circuit for performing the aforesaid multi-gradation processing is often disposed on a preceding stage of an output of a driver of a display. However, if such a structure is adopted for a display having luminance variation among display pixels, there has been a problem that the correction of the uneven luminance and the multi-gradation processing are incompatible with each other to interfere each other due to difference in luminance characteristics among the display pixels, so that good characteristics cannot be obtained in some cases. Moreover, an uneven luminance correction value is digital data and thus includes more or less error. This has posed a problem that static unevenness in luminance may possibly occur.

### SUMMARY OF THE INVENTION

It is an object of the present invention to provide an image display device and an image signal processing device realizing better image display than that in a conventional device even when a display having uneven luminance among display pixels is used.

An image display device according to one of the aspects of the present invention includes: an image display unit including a plurality of display pixels; an input unit to which an image signal as a basis of image display by the image display unit is inputted; a correction memory storing uneven luminance correction values for the respective display pixels; a judging unit judging the inputted image signal; an arithmetic unit performing an arithmetic operation on the uneven luminance correction value read from the correction memory; and a correcting unit correcting the image signal based on the uneven luminance correction value resulting from the arithmetic operation by the arithmetic unit.

An image signal processing device according to another aspect of the present invention is an image signal processing device enabling an image display unit having a plurality of display pixels to display an image, the image signal processing device including: an input unit to which an image signal as a basis of the image display by the image display unit is inputted; a correction memory storing uneven luminance correction values for the respective display pixels; a judging unit judging the inputted image signal; an arithmetic unit performing an arithmetic operation on the uneven luminance correction value read from the correction memory; and a correcting unit correcting the image signal based on the uneven luminance correction value resulting from the arithmetic operation by the arithmetic unit.

### BRIEF DESCRIPTION OF THE DRAWINGS

FIG. 1 is a diagram showing a configuration of an image display device according to one embodiment of the present invention.

FIG. 2 is a diagram showing a configuration of an uneven luminance correcting unit of the image display device in FIG. 1.

FIG. 3 is a chart showing an example of a dither table used for judgment by a judging unit.

FIG. 4 is a flowchart to explain operations of the uneven luminance correcting unit in FIG. 2.

FIG. 5 is a diagram showing a configuration of an uneven luminance correcting unit of an image display device according to a second embodiment of the present invention.

FIG. 6 is a chart to explain an example of outputs from a judging unit.

FIG. 7 is a flowchart to explain operations of the uneven luminance correcting unit in FIG. 5.

### DESCRIPTION OF THE EMBODIMENTS

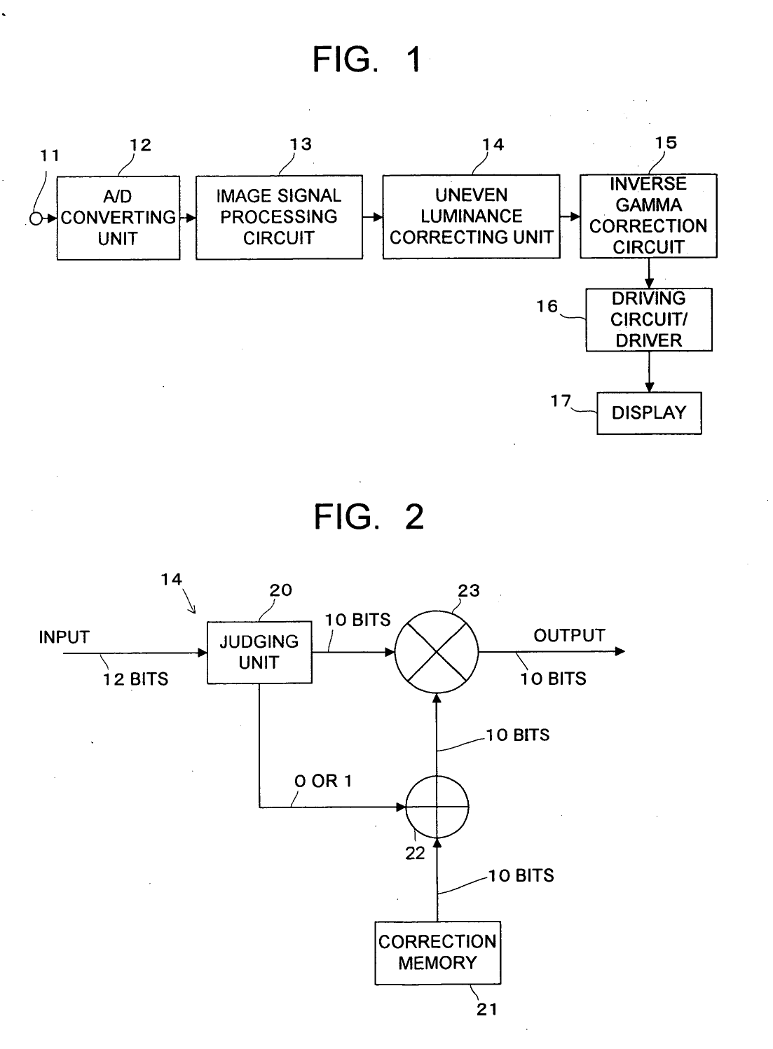

Hereinafter, embodiments of the present invention will be described with reference to the drawings. FIG. 1 schematically shows configuration of an essential part of an image display device according to one embodiment of the present invention. In FIG. 1, 11 denotes an input terminal, 12 denotes an A/D converting unit, 13 denotes an image signal processing circuit, 14 denotes an uneven luminance correcting unit, 15 denotes an inverse Gamma correction circuit, 16 denotes a driving circuit/driver, and 17 denotes a flat display as an image display unit.

An analog image signal and so on extracted from broadcast signals received by a not-shown receiving unit is inputted to the input terminal 11. The analog image signal inputted to the input terminal 11 is inputted to the A/D converting unit 12 to be converted to a digital signal here. The digital signal is next inputted to the image signal processing circuit 13 to be subjected to brightness processing, contrast processing, and the like. The input signal, when being a digital signal, does not go through the A/D converting unit 12 but is inputted to the image signal processing circuit 13.

Thereafter, the image signal is inputted to the uneven luminance correcting unit 14 to be corrected based on a later-described uneven luminance correction value. Then, the image signal is finally inputted to the inverse Gamma correction circuit 15, and after being subjected to inverse Gamma correction here, it is inputted to the driving circuit/driver 16, so that an image is displayed on the flat display 17.

The flat display 17 has m (for example, 720) scan lines extending in a lateral (horizontal) direction, n (for example, 1280×3) signal lines extending in a longitudinal (vertical) direction to intersect with the scan lines, and m×n (for example, about 2 million 760 thousands) display pixels arranged near intersections of the scan lines and the signal lines. Each of the color display pixels consists of horizontally adjacent three display pixels. In this color display pixel, each of the three display pixels has a surface conduction type electron emitting element. The respective display pixels have red (R), green (G), and blue (B) phosphors each emitting light when irradiated with an electron beam emitted from the surface conduction type electron emitting element.

FIG. 2 shows a configuration of the aforesaid uneven luminance correcting unit 14. In FIG. 2, 20 denotes a judging unit, 21 denotes a correction memory, 22 denotes an adder, and 23 denotes a multiplier. In FIG. 2 and FIG. 5 to be described later, the term 10 bits or 12 bits indicates the number of bits of an output signal from each of the units. In FIG. 2, a 12-bit signal is inputted as the image signal from the aforesaid image signal processing circuit 13 in FIG. 1 provided on a preceding stage of the uneven luminance correcting unit 14. Then, a signal outputted from the uneven luminance correcting unit 14 turns to a 10-bit signal in compliance with the specifications of the driving circuit/driver 16.

The aforesaid correction memory 21 stores uneven luminance correction values for the respective display pixels. The uneven luminance correction values are intended for correcting electron emission characteristics that differ among the display pixels in order to realize uniform luminance. Various methods have been known as methods of calculating the uneven luminance correction values. In a case of a surface conduction type electron emitting element, a value of a current that flows when a predetermined test signal is applied has a correlation with the intensity of the emitted electron beam. Therefore, for example, by measuring the current flowing through each of the display pixels (elements), the intensity of the electron beam, namely, luminance of the relevant display pixel can be found. Therefore, it is possible to find the uneven luminance correction value by a method of, for example, comparing the actually measured value and a designed value of the current that flows when the predetermined test signal is applied and dividing the designed value by the measured value. The uneven luminance correction value of each display pixel that emits light according to the inputted image signal is read from the correction memory 21 to be outputted to the adder 22.

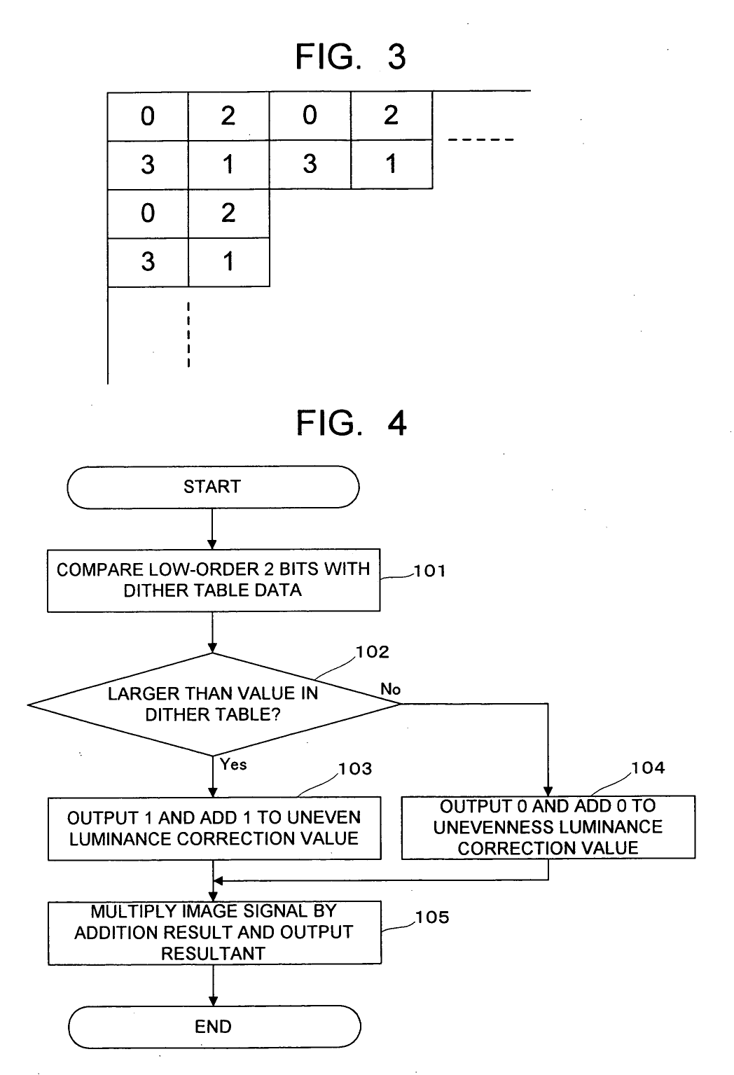

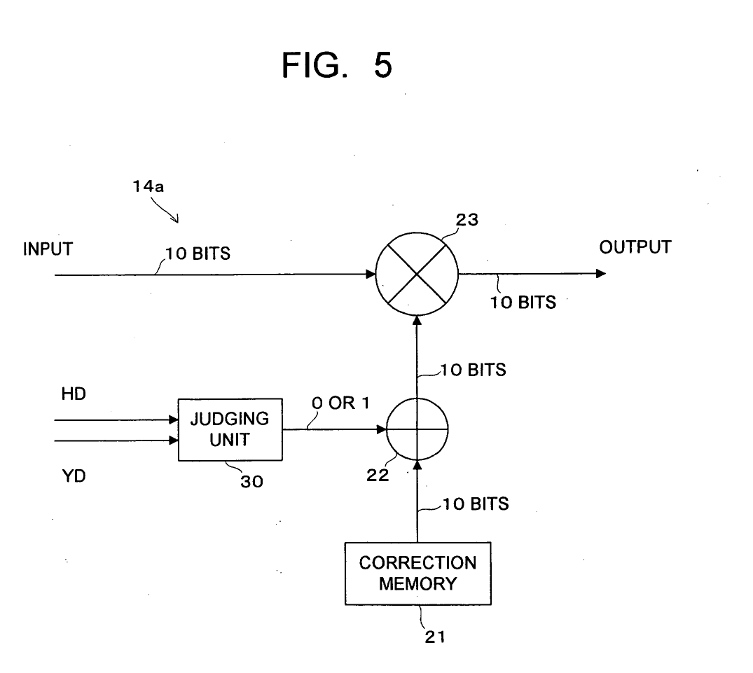

The flowchart in FIG. 4 shows operations of the uneven luminance correcting unit 14. As shown in FIG. 4, for each of the display pixels, the judging unit 20 compares a numerical value of low-order 2 bits of the 12-bit input signal with data in a dither table, for example, as shown in FIG. 3 (101).

Then, when, for example, the numerical value of the low-order 2 bits of the input signal is larger than the data in the dither table (102), 1 is outputted to the adder 22 to be added to the read uneven luminance correction value (103). In other cases, 0 is outputted to the adder 22 to be added to the read uneven luminance correction value (104).

Therefore, when the numerical value of the low-order 2 bits of the input signal is larger than the data in the dither table, the uneven luminance correction value read from the correction memory 21 results in a plus-one value. The multiplier 23 multiplies the image signal (input signal) by this uneven luminance correction value after the correction and the resultant value is outputted (105).

Consequently, the image displayed on the display 17 in FIG. 1, even though being driven by the 10-bit signal, can be a multi-gradation image similarly to an image in the case where the 12-bit signal is used.

In the embodiment as configured above, the uneven luminance correcting unit 14 corrects the uneven luminance correction values read from the correction memory 21 based on the judgment result by the judging unit 20, so that it is possible to realize multi-gradation without providing a separate multi-gradation circuit. In addition, since the processing for such multi-gradation is performed simultaneously with the uneven luminance correction by the uneven luminance correcting unit 14, the uneven luminance correction and the multi-gradation processing do not interfere each other, so that it is possible to obtain a good display characteristic.

FIG. 5 shows a configuration of an uneven luminance correcting unit 14a according to a second embodiment. The uneven luminance correcting unit 14a is disposed in the image display device shown in FIG. 1 in place of the uneven luminance correcting unit 14. In FIG. 5, 21 denotes a correction memory, 22 denotes an adder, 23 denotes a multiplier, and 30 denotes a judging unit that outputs a correction signal to the adder 22 based on a HD (horizontal synchronizing signal) and a VD (vertical synchronizing signal) out of input signals.

Uneven luminance correction values stored in the correction memory 21 are digital data and thus include more or less errors. Specifically, actual luminance is an analog value, but the analog value is rounded up or down when converted to the digital data, and therefore, the uneven luminance correction value accordingly includes an error. Therefore, this error may possibly cause static unevenness in luminance in the image displayed on the display 17 shown in FIG. 1. The uneven luminance correcting unit 14a according to the second embodiment prevents the occurrence of the static unevenness in luminance ascribable to such an error in the digital data to realize good image display.

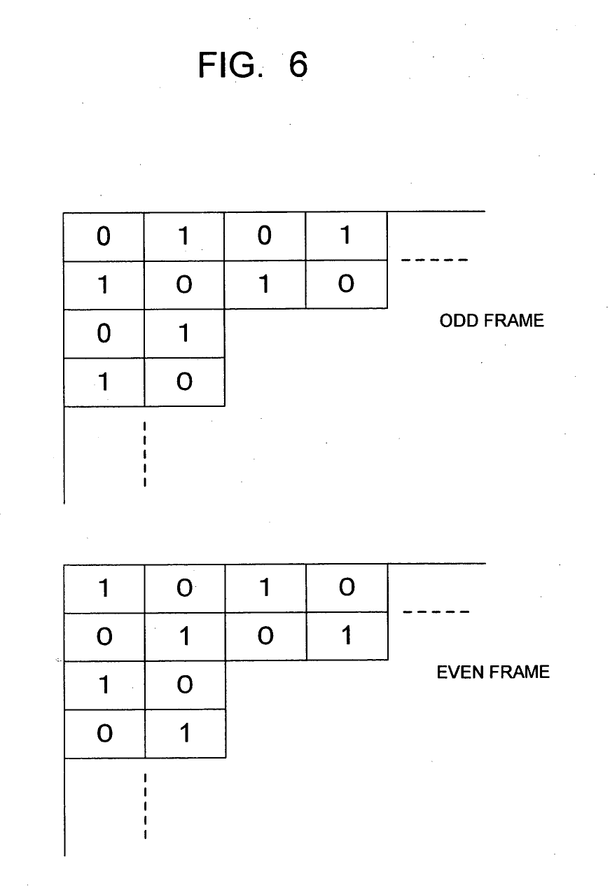

The aforesaid judging unit 30 outputs a correction signal that is intended for correcting the uneven luminance correction values so as to average the aforesaid errors in the uneven luminance correction values. As this correction signal, effective is, for example, a signal such that 0 and 1 are outputted for each display pixel and this output value in an odd frame and that in an even frame are inverted to each other, as shown in FIG. 6.

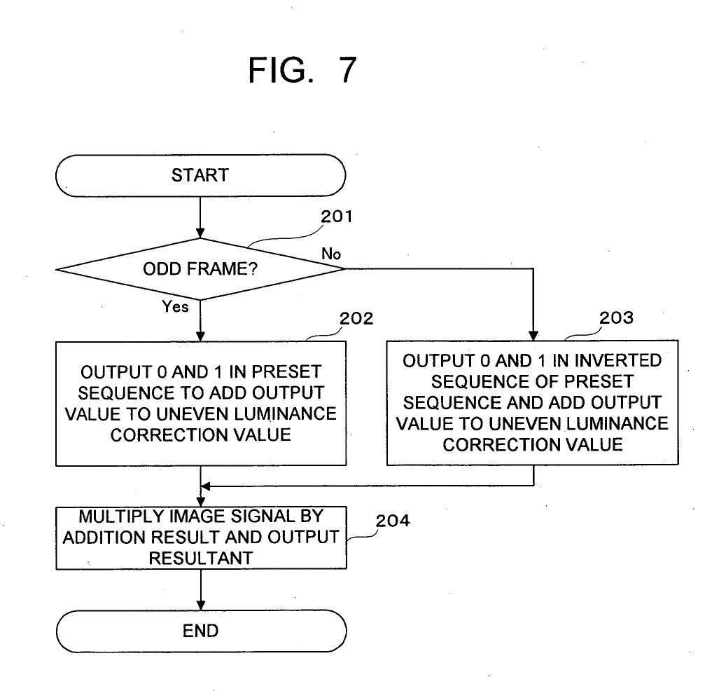

FIG. 7 shows operations of the aforesaid uneven luminance correcting unit 14a. As shown in this drawing, the judging unit 30 judges whether the current frame is an odd frame or an even frame (201), and if the current frame is the even frame, it outputs signals of 0 and 1 for the display pixels in a preset order, for example, alternately, and the adder 22 adds the outputted value to the uneven luminance correction value read from the correction memory 21 (202).

When, on the other hand, it is judged that the current frame is the even frame, the aforesaid order is inverted, that is, display pixels for which 0 was outputted and display pixels for which 1 was outputted are inverted, and the adder 22 adds this data to the uneven luminance correction values read from the correction memory 21 (203).

Then, the multiplier 23 multiplies the image signal (input signal) by the uneven luminance correction value resulting from the aforesaid correction and outputs the resultant value (204).

Consequently, it is possible to prevent the occurrence of the static unevenness in luminance ascribable to the errors included in the uneven luminance correction values which are digital data, so that good display characteristics can be obtained.

It should be noted that the present invention is not limited to the embodiments described above, and it goes without saying that various modifications can be made therein. For example, the correction signal outputted from the judging unit 20 may be one not based on the dither table shown in FIG. 3, but any other correction signal may be used as long as it has a multi-gradation effect. Further, the correction data outputted from the judging unit 30 is not limited to that shown in FIG. 6, either. For example, instead of the correction signal of 0-1, the correction signal can have a larger range such as 0-2.

What is claimed is:

1. An image display device, comprising:
an image display unit including a plurality of display pixels;
an input unit to which an image signal as a basis of image display by said image display unit is inputted;
a correction memory storing uneven luminance correction values for the respective display pixels;
a judging unit judging the inputted image signal;
an arithmetic unit performing an arithmetic operation on the uneven luminance correction value read from said correction memory; and
a correcting unit correcting the image signal based on the uneven luminance correction value resulting from the arithmetic operation by said arithmetic unit.

2. The image display device as set forth in claim 1,
wherein said judging unit judges said inputted image signal to output one of 0 and n (n is an integer) and said arithmetic unit adds the output to the uneven luminance correction value to correct the uneven luminance correction value.

3. The image display device as set forth in claim 2,
wherein said judging unit compares a value of low-order m bits (m is an integer) of the inputted image signal with a preset value in a dither table, and outputs n (n is the integer) when the value of the low-order m bits (m is the integer) is larger than the value in the dither table, while outputting 0 in other cases.

4. The image display device as set forth in claim 2,
wherein said judging unit outputs 0 and n (n is the integer) in a preset order for each of the display pixels, and inverts the display pixels for which 0 is outputted and the display pixels for which n (n is the integer) is outputted frame by frame.

5. An image signal processing device enabling an image display unit having a plurality of display pixels to display an image, the image signal processing device, comprising:
an input unit to which an image signal as a basis of the image display by said image display unit is inputted;
a correction memory storing uneven luminance correction values for the respective display pixels;
a judging unit judging the inputted image signal;
an arithmetic unit performing an arithmetic operation on the uneven luminance correction value read from said correction memory; and
a correcting unit correcting the image signal based on the uneven luminance correction value resulting from the arithmetic operation by said arithmetic unit.
